(19) United States
(12) Patent Application Publication
(10) Pub. No.: US 2019/0278931 A1
(43) Pub. Date: Sep. 12, 2019

(54) SYSTEMS AND METHODS FOR SECURE DATA STORAGE AND RETRIEVAL

(71) Applicant: UBIQ SECURITY, INC., San Diego, CA (US)

(72) Inventors: Eric TOBIAS, La Jolla, CA (US); Anthony IASI, San Diego, CA (US); Charles KAHLE, Escondido, CA (US); Gary SCHNEIR, Carlsbad, CA (US); John TYNER, San Diego, CA (US); Stefano GIACONI, San Diego, CA (US)

(21) Appl. No.: 16/296,152

(22) Filed: Mar. 7, 2019

Related U.S. Application Data
(60) Provisional application No. 62/640,505, filed on Mar. 8, 2018.
(60) Provisional application No. 62/640,516, filed on Mar. 8, 2018.

(51) Int. Cl. G06F 21/62; G06F 21/45; G06F 21/44; G06F 21/31; H04L 9/08; G06F 16/23

(52) U.S. Cl. CPC G06F 21/6218; G06F 21/45; G06F 16/2322; G06F 21/31; H04L 9/0894; G06F 21/44

(57) ABSTRACT

Systems and methods for accessing a first data object are provided. In an aspect, the method comprises: receiving, by a server from a plurality of client devices, a plurality of requests to retrieve a first data object, each client device operated by a user of a plurality of users; generating a plurality of unique data objects based on the requested first data object, each unique data object associated with the first data object and associated with a user of the plurality of users; and for each client device of the plurality of client devices, providing the client device access to a respective unique data object of the plurality unique data objects based on a respective user corresponding to the client device and associated with the respective unique data object.

### CROSS-REFERENCE TO RELATED APPLICATIONS

This application claims the benefit of U.S. Provisional Application No. 62/640,505, filed Mar. 8, 2018, and U.S. Provisional Application No. 62/640,516, filed Mar. 8, 2018, the disclosures of which are incorporated herein in their entirety by reference

This application is related to U.S. application Ser. No. 15/622,033, filed on Jun. 13, 2017, U.S. patent application Ser. No. 15/806,058, filed on Nov. 7, 2017, U.S. paten application Ser. No. 15/411,888, filed on Jan. 20, 2017, U.S. patent application Ser. No. 14/863,294, filed on Sep. 23, 2015, U.S. patent application Ser. No. 14/970,466, filed on Dec. 15, 2015, and now U.S. Pat. No. 10,165,050, granted on Dec. 25, 2018, the disclosures of which are incorporated herein in their entireties by reference.

### BACKGROUND

### 1. Field of the Invention

Various embodiments described herein relate generally to the field of electronic data security, and more particularly to managing access to secured data to resolve conflicting access to secured data by multiple systems. Further, various embodiments described herein relate generally to implementations of electronic data security in integrated circuits, and more particularly to the implementation of application specific integrated circuits (“ASIC”) and/or field programmable gate arrays (“FPGA”).

### 2. Related Art

The vision of a paperless modern society is quickly becoming a reality, as more and more communications, services and transactions take place digitally across networks such as the Internet. The need for paper copies of correspondence, financial documents, receipts, contracts and other legal instruments is dwindling as electronic methods for securely transmitting, updating and accessing these documents increases. In addition to the electronic transmission and access to documents and correspondence, the process of electronically submitting information is also commonplace, such as with online shopping or applications for loans, credit cards, health insurance, college or job applications, etc.

Security of electronic data is of paramount importance for private individuals and for almost every conceivable business and government entity. A tremendous volume of electronic data is being generated, stored, and transmitted on a constant basis. Moreover, the breadth of electronic data, which nowadays inevitably extends to private and sensitive information, necessarily attracts a host of bad actors.

Conventional data security solutions are relatively static. For example, one or more data security mechanisms (e.g., password protection, encryption scheme) may be deployed at a particular data storage location. The same data security mechanisms will generally remain in place until a significant security breach is detected, at which point the entire data storage location may have already been compromised.

Data that has been stored based on standard relational data models are particularly vulnerable to unauthorized access. Individual data records (e.g., name, address, social security number, credit card number, and bank account number) stored in separate storage locations are typically accompanied by a common record locator indicating a logical nexus between the data records (e.g., associated with the same user). For example, individual data records may each be associated with the same user identification number. As such, unauthorized access to any one data record may expose sufficient information (i.e., the user identification number) to gain access to the remainder of the data records.

Although numerous data security methods are available, implementing a flexible roster of seamlessly integrated and complementary data security solutions at a single data storage location remains an enormous challenge. For example, while combining security solutions will normally increase data security, incompatibilities between different solutions may in fact give rise to additional security risks.

Moreover, in order for a user to be able to store and retrieve data, there must be a way to identify that user and protect their data from being accessed by any other user. Traditionally, this is performed by “front-end” software where the user is authenticated and authorized through a login process.

The conventional login process is associated with a number of documented weaknesses. For example, in many systems, the login step is commonly considered a part of the user interface (UI) and a separate entity from the security bubble. The problem is magnified in cases where in-house developers, having limited background in security, attempt to build custom login authentication and authorization systems. As such, a malicious user can potentially have access to other users' data once that user successfully completes the login process.

But these issues are also exacerbated by the fact that much of the data that is created today is created or accessed at a client endpoint, e.g., a computer, laptop, smartphone, tablet, Internet of Things device, etc. Furthermore, users are increasingly attempting to share data so to collaborate and accessed common data, such as documents and files. Thus, these issues are further complicated by the fact that multiple client endpoints data are increasing simultaneously accessing and modifying common data causing race conditions and conflicting access. Even if the issues described above can be solved for data stored and retrieved at a server, there is the additional problem of securing the data and ensuring that such data remains uncorrupted at the endpoint. Thus, any solution to the above issues should take into account the fact that the client endpoint must also be secured and access thereto managed. Furthermore, when multiple users attempt to access common data stored in a file system two or more systems may collide and/or conflict in their attempts to access, read, write, or modify the same file. Thus, there is an inherent risk of data loss when multiple users attempt to access and/or write to the same file located at the same location at the same time. Some approaches attempt to remedy this through file locking, such that a single system is permitted access at a given time. Other approaches attempt to address this situation by providing exclusive access to a host system, such that systems accessing the data do so via communication with the host system. However, these approaches do not have a consistent method to handle race conditions when multiple processes on different host systems attempt to write to the same file when the device is not controlled by one of the host systems. In such a scenario, a race condition can occur where data may be overwritten by a process without consideration or inclusion of modifications entered other processes. Similarly, a race condition may corrupt the data by the competing processes. It is possible that one system may receive indication that the file has been successfully written only to later realize that the data is not as stored as expected.

### SUMMARY

Disclosed herein are systems and methods for secure storage, transmission and management of data, credentials and encryption keys to and from the client endpoint. According to one aspect, a method for reducing race conditions is provided. The method comprises: receiving, by a server from a plurality of client devices, a plurality of requests to retrieve a first data object, each client device operated by a user of a plurality of users; generating a plurality of unique data objects based on the requested first data object, each unique data object associated with the first data object and associated with a user of the plurality of users; and for each client device of the plurality of client devices, providing the client device access to a respective unique data object of the plurality unique data objects based on a respective user corresponding to the client device and associated with the respective unique data object.

According to another aspect, a system for accessing a first data object is provided. The system comprises: one or more storage locations configured to store the first data object, a plurality of unique data objects, the first data object being stored in association with the plurality of unique data objects and the plurality of unique data objects are stored in association with a plurality of users; a plurality of client devices comprising one or more processors, the plurality of client devices operated by a plurality of users; and a secure platform comprising one or more processors and coupled to the one or more storage locations. The secure platform is configured to: receive a request to retrieve the first data object from a first client device of the plurality of client devices; in response to receiving the request from the first client device, retrieve a second data object of the plurality of data objects associated with the first data object and associated with a first user of the plurality of users; and provide the first client device access to the second data object.

Other features and advantages should become apparent from the following description of the preferred embodiments, taken in conjunction with the accompanying drawings.

### BRIEF DESCRIPTION OF THE DRAWINGS

Various embodiments disclosed herein are described in detail with reference to the following figures. The drawings are provided for purposes of illustration only and merely depict typical or exemplary embodiments. These drawings are provided to facilitate the reader's understanding and shall not be considered limiting of the breadth, scope, or applicability of the embodiments. It should be noted that for clarity and ease of illustration, these drawings are not necessarily made to scale.

FIG. 1 is a reproduction of FIG. 1 of U.S. application Ser. No. 14/863,294, the disclosure of which application incorporated herein in its entirety by reference;

FIG. 2 is a reproduction of FIG. 1 of U.S. application Ser. No. 14/970,466, the disclosure of which application is incorporated herein in its entirety by reference;

FIG. 3 is a reproduction of FIG. 1 of U.S. application Ser. No. 15/411,888, the disclosure of which application is incorporated herein in its entirety by reference;

FIG. 4 is a reproduction of FIG. 3 of U.S. Application No. 15/806,058, the disclosure of which application is incorporated herein in its entirety by reference;

FIG. 5 is an example network diagram illustrating a network environment according to various embodiments;

FIGS. 6A-6D illustrate example tables depicting data access change data in accordance with various aspects of the present disclosure;

FIG. 7 is a flowchart illustrating a method for managing race conditions or access conflicts in accordance with various aspects of the present disclosure;

FIG. 8 is a flowchart illustrating a method for generating data access chain data in accordance with various aspects of the present disclosure;

FIG. 9 is a schematic diagram illustrating an example top level block diagram for an example integrated circuit in accordance with various aspects of the present disclosure;

FIGS. 10-13 are example flowcharts illustrating integrated circuit design flows in accordance with various aspects of the present disclosure;

FIG. 14 is a schematic diagram illustrating an example floor plan of an integrated circuit in accordance with various aspects of the present disclosure; and

FIG. 15 is a block diagram illustrating wired or wireless system in accordance with various aspects of the present disclosure.

The various embodiments mentioned above are described in further detail with reference to the aforementioned figures and the following detailed description of exemplary embodiments.

### DETAILED DESCRIPTION

Embodiments disclosed herein provide methods and systems for secure storage and management of data, credentials and encryption keys, specifically including client endpoint protection. After reading this description it will become apparent how to implement the embodiments described in various alternative implementations. Further, although various embodiments are described herein, it is understood that these embodiments are presented by way of example only, and not limitation. As such, this detailed description of various alternative embodiments should not be construed to limit the scope or breadth of the appended claims.

U.S. patent application Ser. No. 14/863,294 (the '294 Application), the disclosure of which is incorporated herein by reference in its entirety as if set forth in full, describes systems and methods for secure high-speed data storage, access, recovery and transmission that involves fragmenting, individually encrypting and dispersing of the data as described therein. For example, as described in the '294 Application, data in a medical record can first be disassociated so that, e.g., the various fields are not logically related. Then the disassociated fields can be decomposed into sub-fields or parts (fragments). These sub-fields can then be obfuscated such that one cannot easily determine the contents of the sub-fields, even if they were to intercept or gain access to them. These sub-fields can then be individually encrypted, e.g., using a different encryption key for each sub field or fragment. The individually encrypted, sub-fields can then be “sharded” and stored on different storage devices or locations.

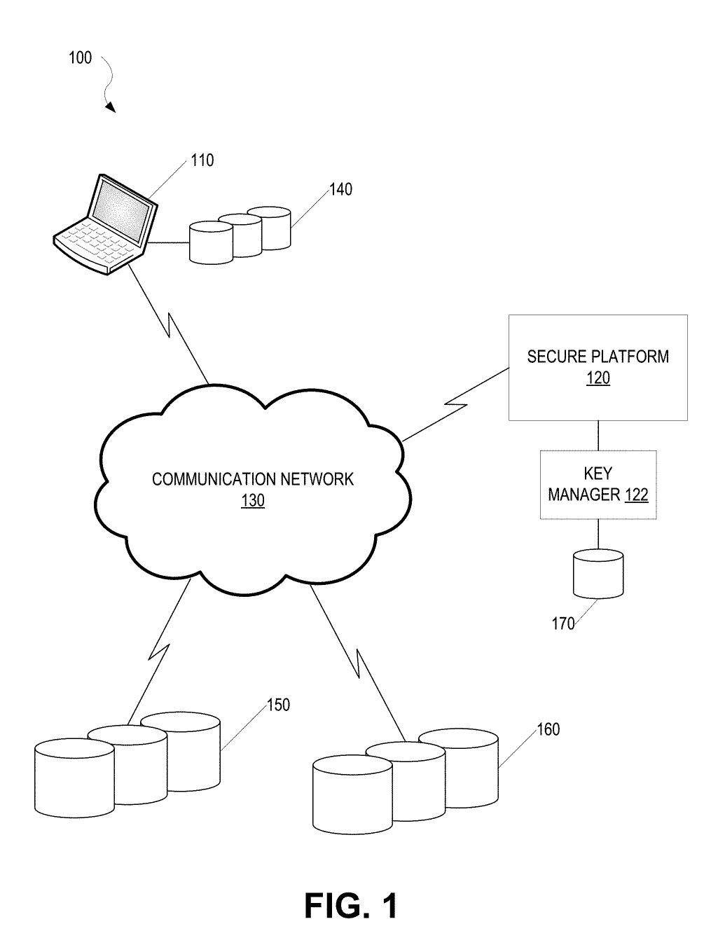

FIG. 1 is a reproduction of FIG. 1 of the '294 Application that illustrates an example system on which the process described can be carried out. As described, with reference to FIG. 1, the process generally occurs on secure platform 120 in response to a command or request initiated on client device 110. The secure platform 120 then stores the encrypted fragments on various storage devices or locations 140, which may be local or locally connected storage devices, or cloud-based file systems 150, 160, for example, cloud platforms, such as but not limited to, AWS, Azure, or the like and/or cloud folder systems, such as but not limited to, Box, Dropbox, iCloud, Google Drive, OneDrive, or the like. While data may be disassembled and stored in different storage device or locations, the processes described in the '294 Application do not necessarily apply to the scenario where multiple systems (e.g., multiple endpoint devices 110 and/or servers 120) attempt to access the same data across the different storage devices or locations at the same time.

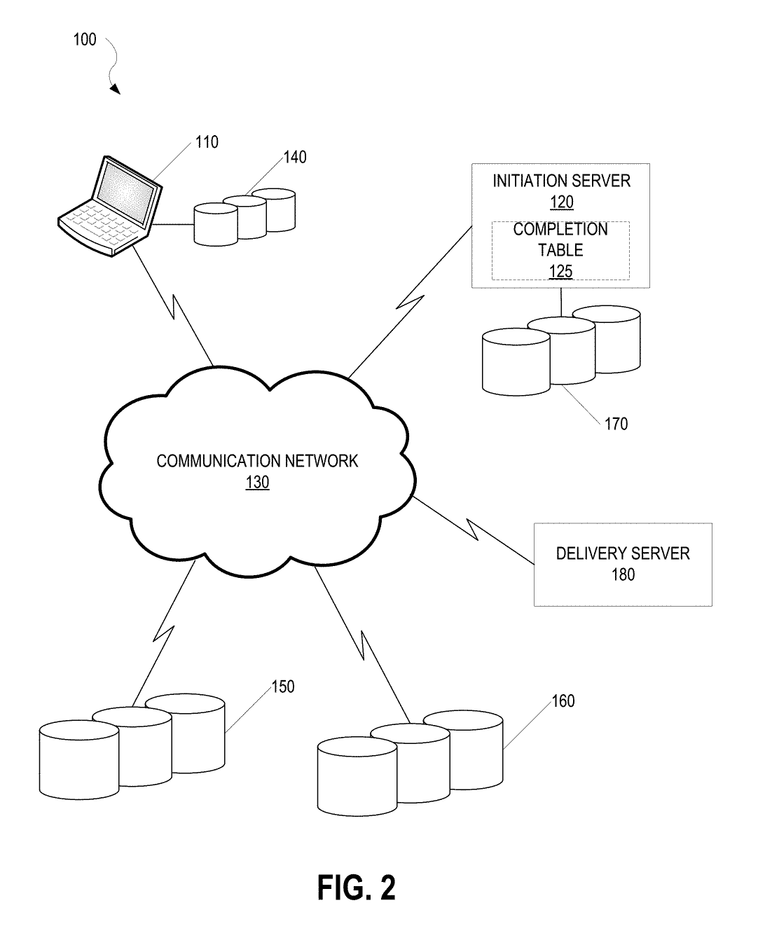

U.S. patent application Ser. No. 14/970,466 (the '466 Application), the disclosure of which is incorporated herein by reference in its entirety as if set forth in full and describes systems and methods for diffracted data retrieval of data that has gone through the processes of the '294 Application. FIG. 2 is a reproduction of FIG. 1 of the '466 Application which illustrates a system for carrying out the diffracted data retrieval described therein. As described with reference to FIG. 2, while the diffracted data retrieval can involve storage device or locations 140, 150 and/or 160, the processes described therein generally do not address simultaneous diffracted data retrieval by multiple systems (e.g., multiple endpoint devices 110 and/or servers 120, 180).

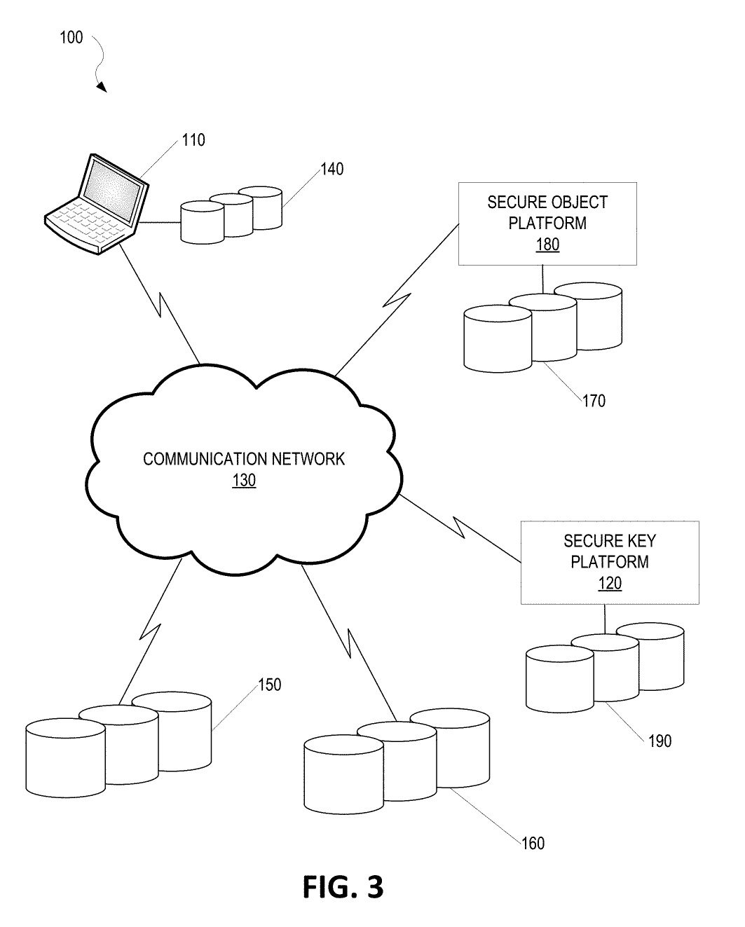

U.S. patent application Ser. No. 15/411,888 (the '888 Application), the disclosure of which is incorporated herein by reference in its entirety as if set forth in full, describes systems and methods for secure storage and management of credentials and encryption keys. FIG. 3 is a reproduction of FIG. 1 the '888 Application which illustrates a system on which the processes described therein can be carried out. As described with reference to FIG. 3, while the secure storage and management of credentials and encryption keys can involve storage device or locations 140, 150, 160, the processes described herein may involve simultaneous data retrieval by multiple systems such as with multiple endpoint devices and/or servers (e.g., multiple endpoint devices 110 and/or servers 120, 180).

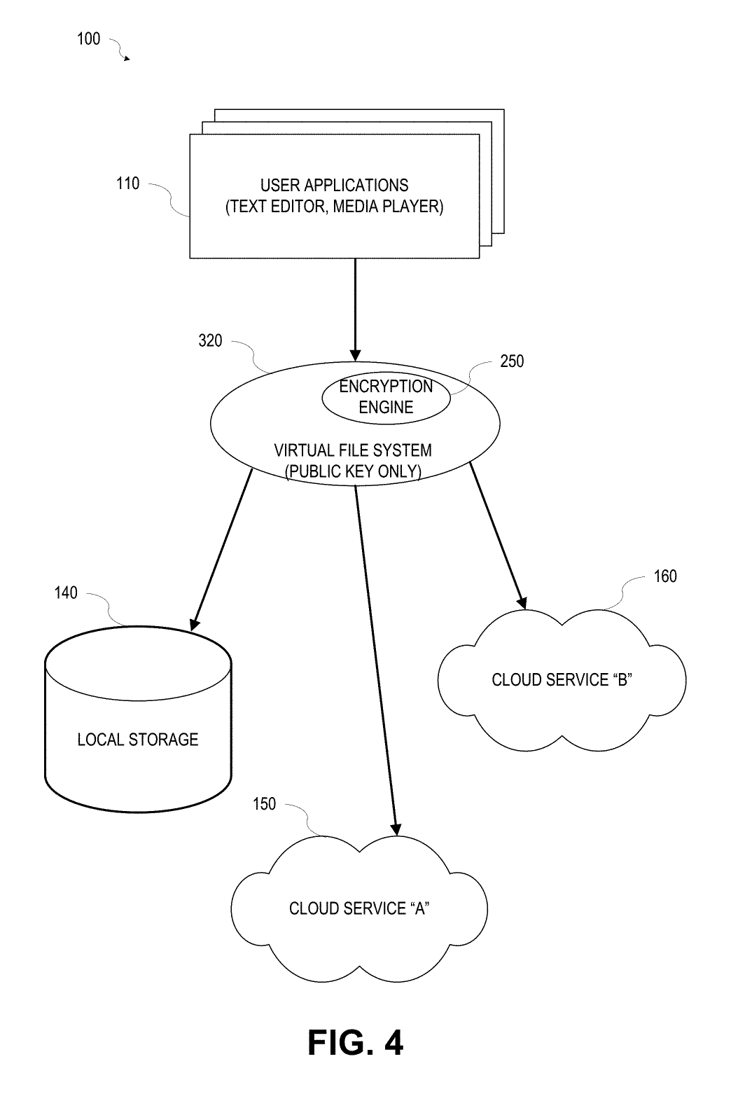

U.S. patent application Ser. No. 15/806,058 (the '058 Application), the disclosure of which is incorporated herein by reference in its entirety as if set forth in full and describes systems and methods for storage of data that has gone through the processes of the '294 Application. FIG. 4 is a reproduction of FIG. 3 of the '058 Application which illustrates a system for storing data with a virtual file system (sometimes referred to as a trusted file manager system) described therein. As described with reference to FIG. 4, while the storage of data within the virtual file system involves storing data fragments at different locations within the virtual file system which can be mapped to virtual cryptological containers (sometimes referred to as data repositories), the processes herein may involve simultaneous data retrieval from data repositories of the trusted file manager system by multiple systems such as with multiple endpoint devices and/or servers.

U.S. patent application Ser. No. * * * * * * (the '* * * * * * Application), the disclosure of which is incorporated herein by reference in its entirety as if set forth in full, describes systems and methods for secure storage of data received as a data stream using the processes of the '294 Application, as well as transmission of data object through secure transmission of the data stream to a remote device using the processes of the '294 Application. While the '* * * * * * Application describes storage of data streams on local or locally connected storage devices or locations 140 simultaneous with transmission to a remote device, the processes described herein may involve simultaneous retrieval of data streams by multiple systems such as with multiple endpoint devices and/or servers.

In accordance with the systems and methods described herein, the processes described in the '294, '466, '888, '058, and '* * * * * * Applications can be implemented at the edge of the system 100, e.g., on client endpoint device 110 (such as, but not limited to, desktops, a laptop, portable electronic devices such as tablets, smartphones, wearable electronic devices, etc.) as illustrated in FIGS. 1-4 and described in Co-Pending U.S. patent application Ser. No. * * * * * * (the '̂̂̂ Application), the disclosure of which is incorporated herein by reference in its entirety as if set forth in full. In some embodiments, access to the system can be provided by an application interface (e.g., APIs and/or SDKs) through software running on the endpoint device 110, or through an application running on a portable electronic device such as a tablet or smartphone. Additionally, the system can be accessible over a web-based application interface, where all of the user's information is securely stored, e.g., in a secure server facility in a cloud-based network. Such implementation may be executed as a thick or thin client running on the endpoint device 110, all of which may be collectively referred to herein as a “client” and/or “local client.” For example, a client can be loaded to a device 110, such that data can be saved to and retrieved from different locations of local or locally connected storage device 140 described in the '294, '466, '888, '058, '* * * * * *, and '̂̂̂ Applications (collectively referred to herein as “the related Applications”) or such that the data can be saved and stored to a plurality of storage devices 140-160. Thus, if the user of device 110 creates a document, video, picture, etc., the user can invoke the client to store and or retrieve the document or file. This can involve doing all the steps described above and in the '294 Application. Similarly, the client can perform the diffractive retrieval of the data or file as described in '466 Application and can enforce the management of credentials and encryption keys as described in '888 Application. Furthermore, the client can perform storage of data within the virtual file system as described in the '058 Application. Additionally, the client can perform the secure storage, transmission, and playback as described in the '* * * * * * Application.

### (a) Data Access Chain

When accessing data that is distributed to a plurality of storage locations as described, for example, in the related Applications, processes performed by two or more systems may collide and/or conflict in attempts to access, read, write, or modify a common data object. Such collisions may cause race conditions that can include an inherent risk of data loss. For example, when two users operating different endpoint devices both attempt to write to a common data object (e.g., a file, document, video, etc.), both users may receive an indication that the write operation was successful. However, due to race conditions and colliding processes, data written by one user will be overwritten by the other user write operation.

In accordance with various aspects of the present disclosure, one or more systems and/or devices may retrieve and/or may write or otherwise store data through implementation of the processes and systems described in the related Applications. Through access by multiple systems and devices, various embodiments permit for sharing and collaboration of data stored therein.

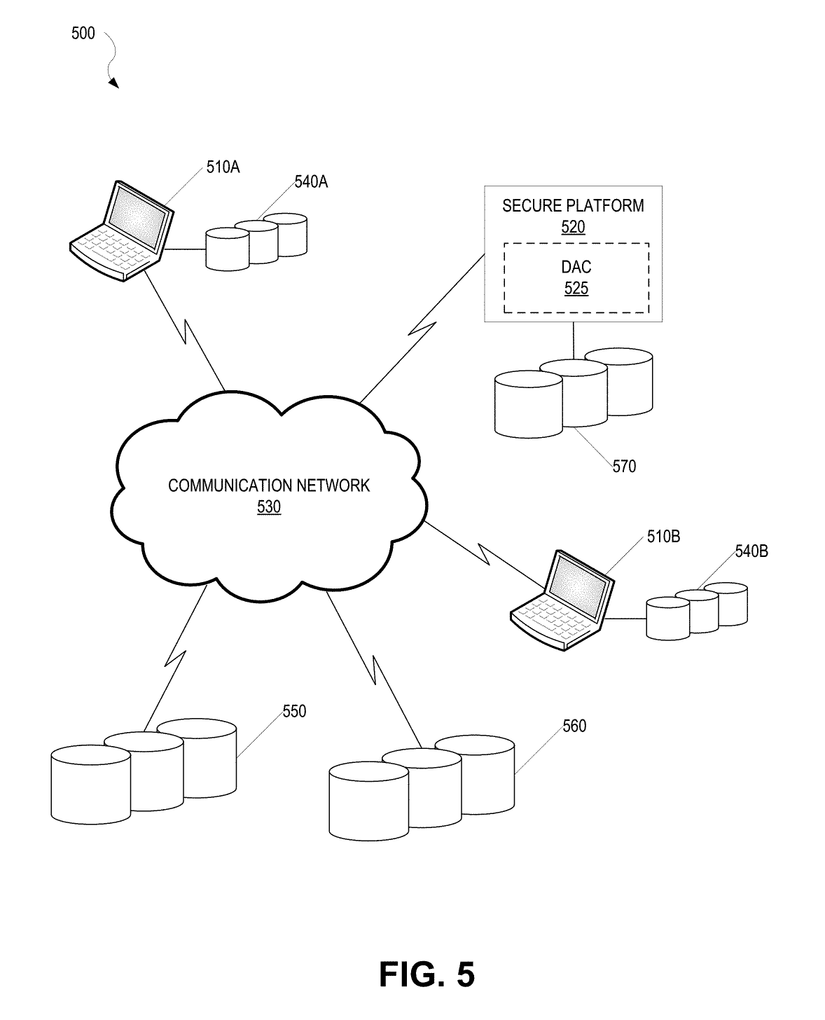

FIG. 5 is a diagram illustrating a system 500 according to various aspects of the present disclosure that may be configured to minimize or avoid the risk of race conditions. In various embodiments, system 500 comprises a plurality of user endpoint devices, for example, devices 510A and 510B (collectively “devices 510”), in communication with a secure platform 520. The secure platform 520 may be configured to perform one or more of the functions and processes described in each of the related Applications. Each device 510 can be any device capable of communication with or causing communication with the secure platform 520 through a wired or a wireless connection. For example, the devices 510 may be a wired or wireless communication device including, for example, but not limited to, a smartphone, a wearable device, a tablet personal computer (PC), a laptop, a desktop PC, a personal entertainment system, and an embedded processing system.

Each device 510 may communicate with the secure platform 520 via a communication network 530. In various embodiments, the communication network 530 represents one or more wired and/or wireless connections. For example, the communication network 130 may include, for example, but is not limited to, a wired and/or wireless local area network (LAN), a wired and/or wireless wide area network (WAN), and any combination thereof.

In various embodiments, the secure platform 520 may be configured to store and retrieve a data object using the processes described in the related Applications. For example, during a session, a user device (e.g., device 510A, 510B, or another device) may store a data object by inputting, selecting, or otherwise invoking a saveData( )command. Each user device 510 may also cause the secure platform 520 to retrieve the data object as well as any metadata that may be associated with the data object by inputting, selecting, or otherwise invoking a getData( )command through the client provided via the user device 510, for example, using the processes described in the related Applications. It is to be understood that reference to the data object throughout the present disclosure extends to any metadata that is associated with the data object. As such, any operation that is performed with respect to the data object (e.g., storing and retrieving the data object) is performed with respect to both the data object and any metadata associated with the data object.

In response to a request to store a data object from a user device 510, the secure platform 520 may generate a data access chain (DAC) 525. The DAC 525 may comprise data corresponding to the data object and indicative of actions performed with respect to the data object on the system 500. The users via endpoint devices (e.g., user device 510 or another device) may perform one or more actions related to the data object, including, but not limited to, store, create, access, write to, view, delete, modify and/or edit, etc. a data object. Each action may be stored as a data entry within the DAC 525 and associated with the data object. In various embodiments, the DAC 525 may comprise metadata related to the data object.

In some embodiments, the DAC 525 may also comprise, for each action, an identifier of the user and/or device (e.g., name, IP address, model number, etc.), a timestamp of the date and time of the action, and an identifier of the data object (e.g., a file name, location(s), etc.). In various embodiments, the DAC 525 may also comprise a second file name (sometimes referred to herein as “unique file name”). As will be described below, the secure platform 520 may be configured to reduce and/or resolve race conditions and conflicting data access by multiple users, at least in part, based on the second file name included in the DAC 525.

Accordingly, in various embodiments, a DAC 525 may be associated with a first data object and comprise a plurality of data entries, for example, related to the data object. Each data entry may correspond to a user of a plurality of users and comprise an action and/or process performed on the data object within the system by the user, a first data object identifier and a second object identifier unique to the user. The DAC 525 may also be associated with a second data object corresponding to the second data object identifier. Thus, a data object may also correspond to a plurality of unique data objects that are each associated with a user of the plurality of users.

In some embodiments, the DAC 525 comprises a data structure including a plurality of directories corresponding to each data object and a plurality of entries for each action related to the respective data object. In another embodiment, separate DAC 525 may be generated for each data object and stored in one or more storage locations within the system, each DAC comprising a plurality of entries for each action related to the respective data object. The storage location may be the same as the location(s) of the data object or may be different storage locations.

In response to the request to retrieve data from either device 510, the secure platform 520 may be configured retrieve the DAC 525 corresponding to the requested data object. For example, the secure platform may receive the file name of the data object via the user getData( ) command and identify the DAC directory or entry corresponding to the file name. Once identified, the DAC 525 may be retrieved or otherwise accessed by the secure platform. In some embodiments, the DAC 525 may be retrieved as described, for example, in the '466 Application. The secure platform 520 may be configured to determine an action performed related to the data object, for example, based on a command received from device 510. For example, the getData( ) command may be representative of an access or read action. A saveData( ) command may be representative of either a create action (where a data object was not previously stored) or a write action (where the action is performed in relation to an existing data object). A modify action may be determined, for example, by comparing an accessed data object with subsequently a saved data object of the same identifier; and if a difference in content, size, and/or otherwise exists, then the data object has been modified or altered.

In some embodiments, when a data object is created, a new directory within the DAC 525 may be generated or a new DAC 525 for that data object may be generated. The secure platform 520 may populate the DAC 525 based on user identifier information corresponding to the requesting user and data object identifier information included with the request, such that the user is associated with the action and data object is recorded in the DAC 525. The secure platform 520 may also record timestamp information that is indicative of either when the request was received, when access is granted to the data object, and/or a write operation is performed with respect to the data object. In various embodiments, the secure platform 520 may also generate a unique data object identifier corresponding to the user based on translating the data object identifier (e.g., file name). In various embodiments, the secure platform 520 may be configured to reduce and/or resolve race conditions and conflicting data access by multiple users, at least in part, based on the unique file name included in the DAC 525.

The DAC 525 may be stored in one or more storage device 550, 560, and/or 570 in accordance with the various aspects for the present disclosure. In some embodiments, the DAC 525 may be disassembled and encrypted as described in the '294 Application.

In some embodiments, in response to a request to store or retrieve data received by the platform 520 from either device 510, the secure platform 520 may be configured to authenticate the device 510 and/or the user of device 510 through, for example, the authentication and credential management processes described, e.g., in the '888 and/or '̂̂̂ Applications. Thus, certain individuals and devices may be granted access, which may be managed using the secure keys generated, e.g., based in the credentials assigned to those individuals. In some embodiments, access to the secure platform 520 may be granted separate from access to the requested data object, for example, based on different credentials and/or security keys.

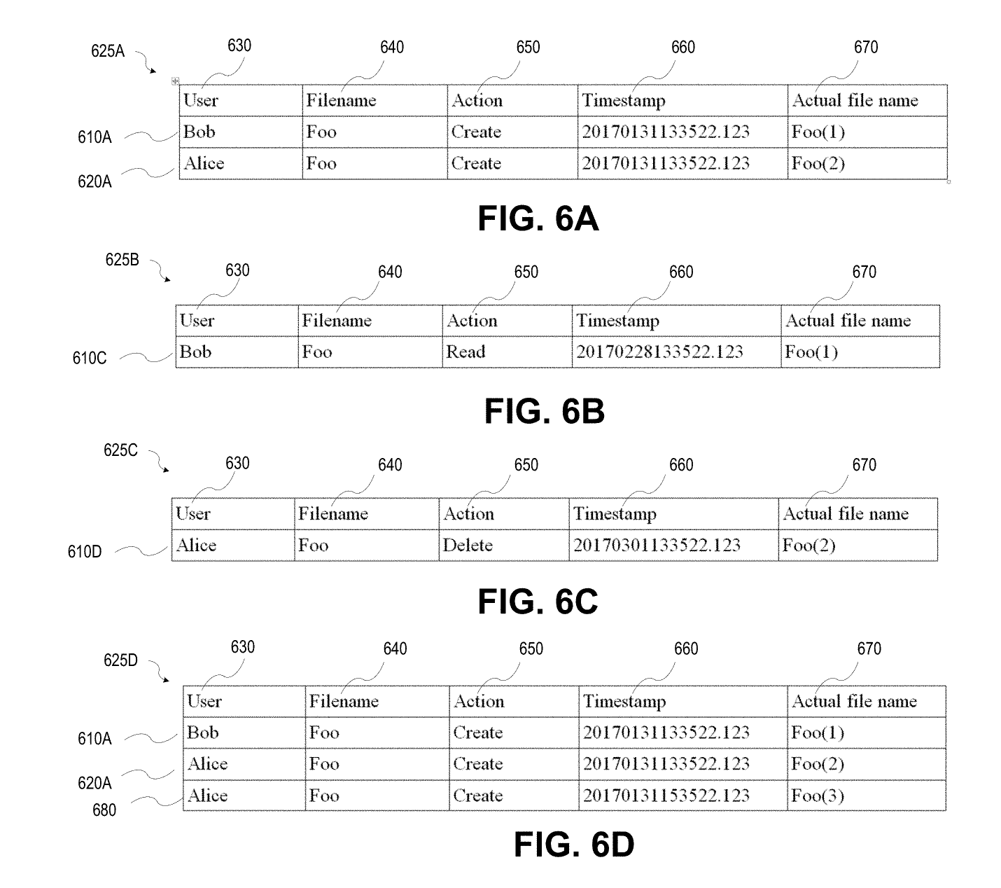

FIGS. 6A-6D illustrate example DAC tables 625A-D according to various embodiments. DAC tables 625A-D illustrate an organized representation of data included, for example, in DAC 525 as described above. Each table 625A-D may be part of a larger whole and are intended for illustrative purposes only. DAC tables 625A-625D comprise a plurality of entries 610-620 and 680 including at least some of the data that may be comprised in the DAC 525. For example, DAC table 625A illustrates two entries, 610A and 620A, that each comprise data representative of a user identifier 630, data object identifier 640, action identifier 650, timestamp 660, and unique data identifier 670. In some embodiments, DAC tables 625A-625D may be example entries located within a directory of DAC 525 of a given data object.

The DAC described herein provide numerous advantageous aspects in accordance with the present description. Various embodiments provide for a DAC of the present description that may be used by a platform or system to reduce and/or resolve race conditions and conflicting actions performed by multiple users related to a common data object. For example, in conventional systems, when two or more devices or systems access a common data object (e.g., the same data object stored at the same location(s)), race conditions or colliding processes may occur. That is, where the two or more devices attempt to access, modify, and/or write to the same data object, data loss may occur due to, for example, overwritten and/or data corruption of the data object. As an example, consider two users, e.g., Alice operating a first device and Bob operating a second device, both attempt to write to a common data object stored in a file system. While both Alice and Bob may receive an indication that a write operation was successful, one user's data may be overwritten by the other due to race conditions and naming conflicts. For example, both Alice and Bob may have accessed a common file (e.g., a common data object), and while Bob has access to the file, Alice edits and writes to the file. Then at some point afterwards, Bob writes to the file. Since both Alice and Bob had the common file open at the same time, Bob's write action may overwrite Alice's and the data written by Alice is lost.

Advantageously, the platforms and servers act in accordance with the aspects of the present disclosure (e.g., secure platform 520 among others described above) may be configured to avoid this scenario by implementing the various aspects of the present disclosure. In various embodiments, the secure platform 520 may be configured, in response to a request to retrieve a data object, to create a unique data object corresponding to a requested data object. The unique data object may be the same content as the requested data object, except that some data descriptive of the data object differs from the requested data object. For example, the data object identifier may be translated to a unique data object identifier associated with the requesting user. That is, a unique data object is associated with a given user, and when the user requests the data object, the user accesses and writes to the unique data object. Accordingly, the user may not be accessing the original data object, which may permit a second user unhindered access thereto. The unique data object identifier may be stored as part of the DAC (e.g., as unique object identifier 670). In various embodiments, the user may be unaware of the changed identifier and access the data object as if accessing the originally requested data object. In some embodiments, translating the object identifier may comprise modifying or changing one or more portions of the metadata of the requested data object.

As an example scenario, with reference to FIGS. 5 and 6A, user Bob may operate device 510B and request a data object entitled “Foo” from the secure platform 520. The secure platform 520 identifies the data object Foo, accesses DAC 625A, and generates a unique data object having unique data object identifier “Foo(1).” The secure platform 520 provides Foo(1) to Bob, who may perform his desired action thereto, and writes to Foo(1). In various embodiments, Alice may operate user device 510A to request data object Foo as well. The secure platform 520 may similarly generate unique data object Foo(2) that is the same as Foo except for the unique data object identifier, to which Alice may write. Foo(2) may comprise the same content but have differing metadata, such as for example, a different identifier. Thus, each user may be associated with a corresponding unique data object based on the DAC 625. Each user then writes to their respective unique data objects (e.g., Foo(1) and Foo(2)), which may ensure that data is not lost while the users write to their respective data objects.

In some embodiments, when each user writes to their respective data object, entries 610A and 620B may be generated and stored in DAC 625A. Thus, when either Alice or Bob attempts to request the data object Foo at a later time, the secure platform 520 may identify the respective user and retrieve the unique data object corresponding to the user. Thus, both Alice and Bob may be able to retrieve the data object as they last left it regardless of actions performed by other users on the file Foo.

In some embodiments, the secure platform 520 may create each unique data object in response to a request to retrieve a data object. That is, when Bob requests Foo, Foo(1) is created and vice versa. In some embodiments, the secure platform 520 may create a unique data object for only those users that request a common data object after a first user. For example, Bob may request access to Foo and be granted access thereto. Then at a later point, Alice requests access to Foo and Foo(2) is generated. Thus, Foo may be associated with Bob and Foo(2) with Alice. Furthermore, the unique data object may be created only where conflicting access is present; that is, if Alice attempts to access Foo while Bob has access to either Foo or Foo(1), then Foo(2) is created and associated with Alice. Otherwise, Alice may be granted access to Foo. Accordingly, in some embodiments, the unique data object may be temporary and associated with each user to the extent that race conditions exist. In another embodiment, alone or in combination, the unique data object may be maintained in the system as long as each unique data object differs (in bit size, file name, content, etc.) from another unique data object (e.g., Foo(1) compared to Foo(2)) and/or from the requested data object (e.g., Foo(1) compared to Foo and/or Foo(2) compared to Foo). In one embodiment, the unique data object may be created before and/or after authenticating the user and/or device.

In some embodiments, the secure platform 520 may be configured to monitor activity related to a given data object based on the DAC, for example, implemented as an activity log. As explained above, the DAC may map or record activity on the system related to a given data object, and the secure platform 520 (or users thereof) may then utilize this log to track and otherwise monitor access and action related to given data object by other users. For example, FIG. 6B illustrates an example DAC table 625B, where Bob has read the unique data object Foo(1). The secure platform 520 may have received a request from Bob to access Foo, determined that Foo(1) is associated with Bob, and provided access to Foo(1). When Bob accessed Foo(1), without writing to Foo(1), the secure platform 520 determined a read action was performed on Foo(1) and mapped this action, timestamp, etc. to entry 610C. Similarly, FIG. 6C, illustrates an entry 610D where either Alice has deleted the unique data object (Foo(2)) corresponding to her or the secure platform 520 determined that Alice is no longer in need of the corresponding unique data object and removed it from the system. In various embodiments, this may permit users to review access to and modifications on the data objects within the system to provide another layer of security and monitoring. For example, ensuring only authorized users have access to the data object by identifying interlopers. Furthermore, monitoring of who has performed what action with respect to the data object is facilitated through the DAC in accordance with embodiments herein.

In some embodiments, some users may be restricted from accessing DAC entries related to other users. Access to DAC entries may be based in part on predefined access control rights and permissions within the system 500 (e.g., as set during configuration of the client on the user device or within the secure platform 520). For example, if Bob requests access to Foo, the secure platform 520 may present DAC 625B such that Bob is only able to view his activity. Activity performed by Alice may not be shown to Bob, where Bob does not have such access rights.

In various embodiments, when a user requests to overwrite the requested data object, the secure platform 520 may be configured to generate a unique data object configured to overwrite the existing requested data object. For example, referring to FIG. 6D, the secure platform 520 may be configured to create Foo(3) in response to a request to overwrite Foo, for example, by Alice. The additional unique data object Foo(3) was created and may provide versioning information of the requested data object Foo. In some embodiments, any users (e.g., Bob and/or Alice in this example) may be permitted access to one or more previous versions that have not been deleted. Thus, advantageously, avoiding any loss of data in any of the previous versions.

DAC data can be stored, distributed, consolidated, and synchronized in a number of ways. For example, one or more databases may be coupled to each client running on devices operated by each user, for example, a SQL or non-SQL database. In some embodiments, alone or in combination, the DAC data may be stored in a distributed databased with replication, for example, where each database may be connected to one or more devices used to access the secure platform. The DAC data may then be distributed, consolidated, and synchronized to other databases within the environment. In another embodiment, alone or in combination, blockchain methodologies may be implemented to store the DAC as smaller pieces (e.g., blocks) of information. The pieces may then be distributed and consolidated into a blockchain that can be synchronized across a plurality of network nodes in the system (e.g., system 500). In still another embodiment, alone or in combination, a single network node may be configured to manage a file comprising the DAC data and manage actions related to data objects to monitor and avoid race conditions and access conflicts in accordance with various aspects of the present disclosure.

In various embodiments, access to the system can be provided by an application interface through software running on a computing device such as a desktop or laptop, or through an application running on a portable electronic device such as a tablet or smartphone. Additionally, the system can be accessible over a web-based application interface, where all of the user's information is securely stored, e.g., in a secure server facility in a cloud-based network.

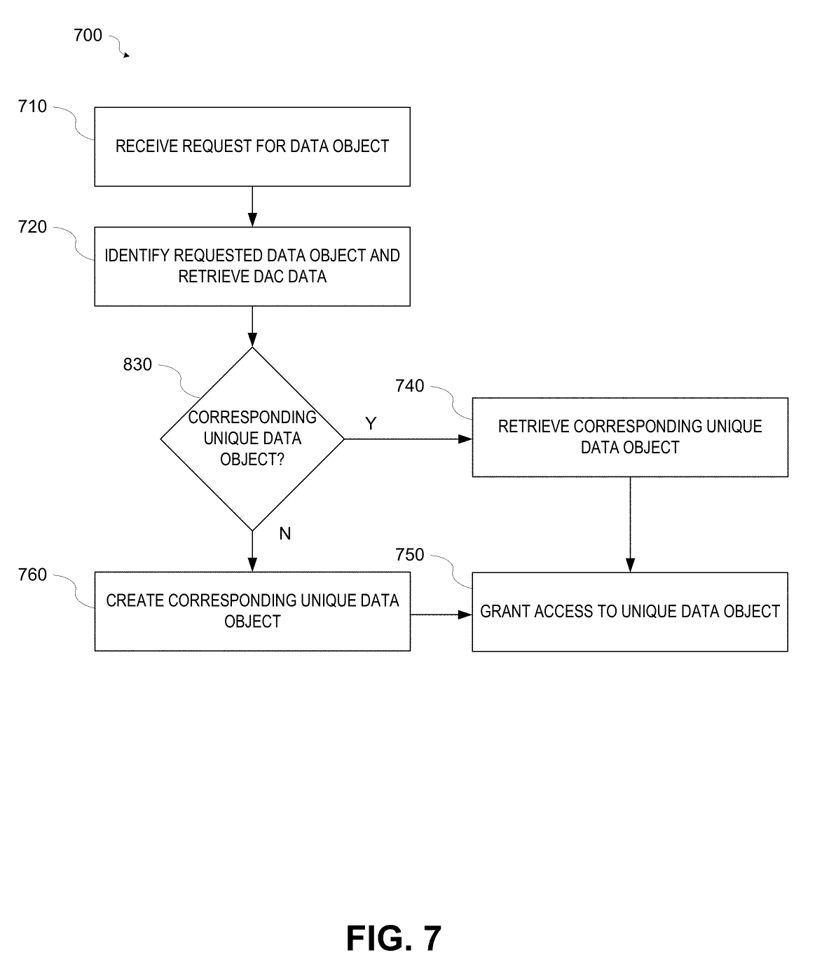

FIG. 7 is a flowchart illustrating a method 700 for minimizing race conditions and colliding access in accordance with various aspects of the present disclosure. Referring to FIG. 7, at block 710, a request to access a data object may be initiated, for example, by a device. At block 720, the requested data object may be identified, and a corresponding DAC retrieved. In some embodiments, the DAC is retrieved based at least in part on a data object identifier included in the data access request. At block 730, determination may be made as to whether a unique data object corresponding to the user (or device) that initiated block 710 exists within the system. In various embodiments, the determination may be based on evaluating the retrieved DAC, for example, by identifying a unique data object identifier associated with the user (or device).

In response to determining that a unique data object exists (730-Y), at block 740 the unique data object is retrieved, and access may be granted at block 750. In response to determining that a unique data object does not exist (730-N), at block 760 a unique data object is created corresponding to the initiating user (or device) and access to the unique data object is granted at block 750.

In some embodiments, a client endpoint device may access the server through an application interface as described above. For example, the client device may send the request of block 810 via the application interface to the secure platform. The secure platform may then identify the data object and retrieve the DAC data to determine whether a unique data object exists. If the unique data object does not exist, then at block 860 the unique data object is created, and access granted to the client device through the application interface. Similarly, at block 840, the unique data object can be retrieved, and access granted via the application interface. In some embodiments, the client device may remotely access the unique data object. For example, through a web-based interface, VPN, or other remote access whereby the application interface communicates instructions to the secure platform for interacting with the unique data object. The unique data object may not leave the secure platform. In another embodiment, the secure platform may transmit the unique data object to the client device through the application interface, which may be stored in a local or locally connected storage device. The application interface may be configured to monitor activity on the unique data object and send this information to the secure platform for inclusion in the DAC data. As such, the unique data object may be locally available to the client device, while maintaining logging of DAC data. In some embodiments, method 700 may follow authenticating a user and/or device. In some embodiments, the method 700 may be initiated when a second user requests access to a data object, while a first user has access to the same data object. For example, either after block 810 or after block 820, an optional determination may be made that the request of block 810 is made for a data object currently accessed by another user. If NO, then access may be granted to the request data object. If YES, then the process 700 may proceed as described above.

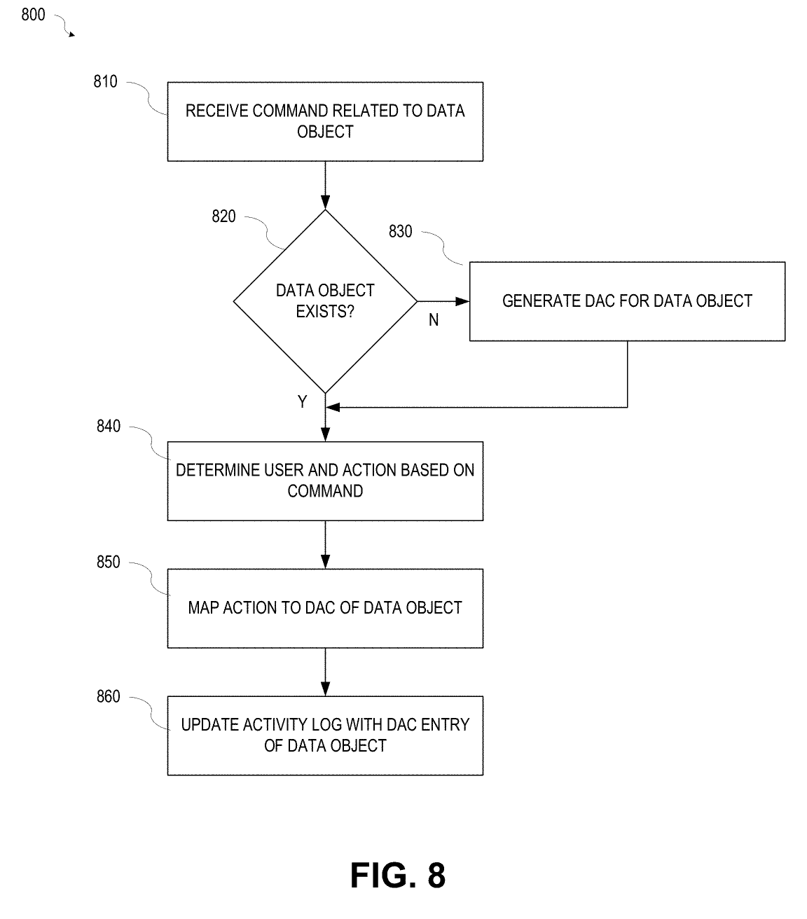

FIG. 8 is a flowchart illustrating a method 800 for generating an entry in a DAC in accordance with various aspects of the present disclosure. Referring to FIG. 8, at block 810, a command related to a data object is received. For example, a command to create, save, delete, access, etc. may be received from an endpoint device. At block 820, a determination is made whether the data object of block 810 exists. For example, the data object may be stored within the system for access and/or retrieval. Alternatively, the data object may not exist because it has not been created yet, and, in this case, block 810 may be a request to save or write a new data object and/or unique data object. If the determination at block 820 is NO, at block 830 a DAC may be created, for example, at approximately the same time as creating the data object and associated with the data object.

If the determination at block 820 is YES or after block 830, the user (or device) that initiated the command at block 810 and the action to be performed in relation to the data object is determined, for example, based on the received command. For example, the user may be identified by a name, user ID, model of device, etc. included with the command. The action may be a getData( ) saveData( ) or the like and may be indicative of a type of action. As explained above, getData( ) may be a request to access a data object, while saveData( ) may be indicative of a write operation. Depending on whether the data object has changed following a saveData( )command, the data object may have been modified or simply read. Additionally, the determination in block 840 may be that the data object (or unique data object) has been deleted.

At block 850, the action and user are mapped to the DAC of the data object indicated in block 810. For example, an entry may be generated and populated in accordance with the various aspects of the present disclosure. At block 860, the activity log (or DAC table) is updated to include the entry mapped in block 850.

### (b) Integrated Circuit Implemented Embodiment

Advances in semiconductor device fabrication technology have yielded a steady decline in the size of process nodes (e.g., minimum fabrication feature size). The decrease in process node size allows a growing number of intellectual property (IP) cores or IP blocks to be placed on a single chip. That is, modern integrated circuit (IC) designs often spread numerous process nodes across a comparatively large die, and include various combinations of IP blocks and logic functions. ICs provide various advantages over conventional approaches, including, but not limited to, decreased cost due to IC chips being printed as a unit via, for example, photolithography, as opposed to construction of one transistor at a time, and improved performance as the components switch quickly and consume comparatively less power.

Thus, in accordance with the systems and methods described herein, one or more of the processes described in the related Applications can be implemented onto an integrated circuit as one or more IP blocks. That is, an integrated circuit may be designed and manufactured that is configured to perform all the steps described above and in the '294 Application. Similarly, the integrated circuit can perform the diffractive retrieval of the data or file as described in '466 Application and can interface with systems to enforce the management of credentials and encryption keys as described in '888 Application. Furthermore, the integrated circuit can interface with a virtual file system as described in the '058 Application and distribute data fragments based on virtual cryptological containers. Additionally, the integrated circuit can perform that secure storage, transmission, and playback as described in the '* * * * * * Application. Implementing the processes and methods described herein as an IC may provide improved performance (e.g., processing speed, power consumption, etc.) of the processes as compared to purely software implementation. Additionally, execution via logic gates and elements of IC implementations provide for improved safeguards of the processes and data transfers from external tampering. Whereas, programming language and compiled object code implementations may be more easily reverse-engineered and intercepted.

As used herein the term “integrated circuit” may refer to a set of electronic circuits that comprise a single die or a multiple dies of semiconductor material connected to create a single chip. The various embodiments described herein may be implemented as application specific integrated circuits (ASIC), field-programmable gate arrays (FPGA), and the like. In some embodiments, the integrated circuit may also be implemented in a circuit board having different microchips performing the various functions described herein. Various embodiments may be manufactured from materials used in semiconductor manufacturing, for example, but not limited, materials comprising silicon, gallium, germanium, etc.

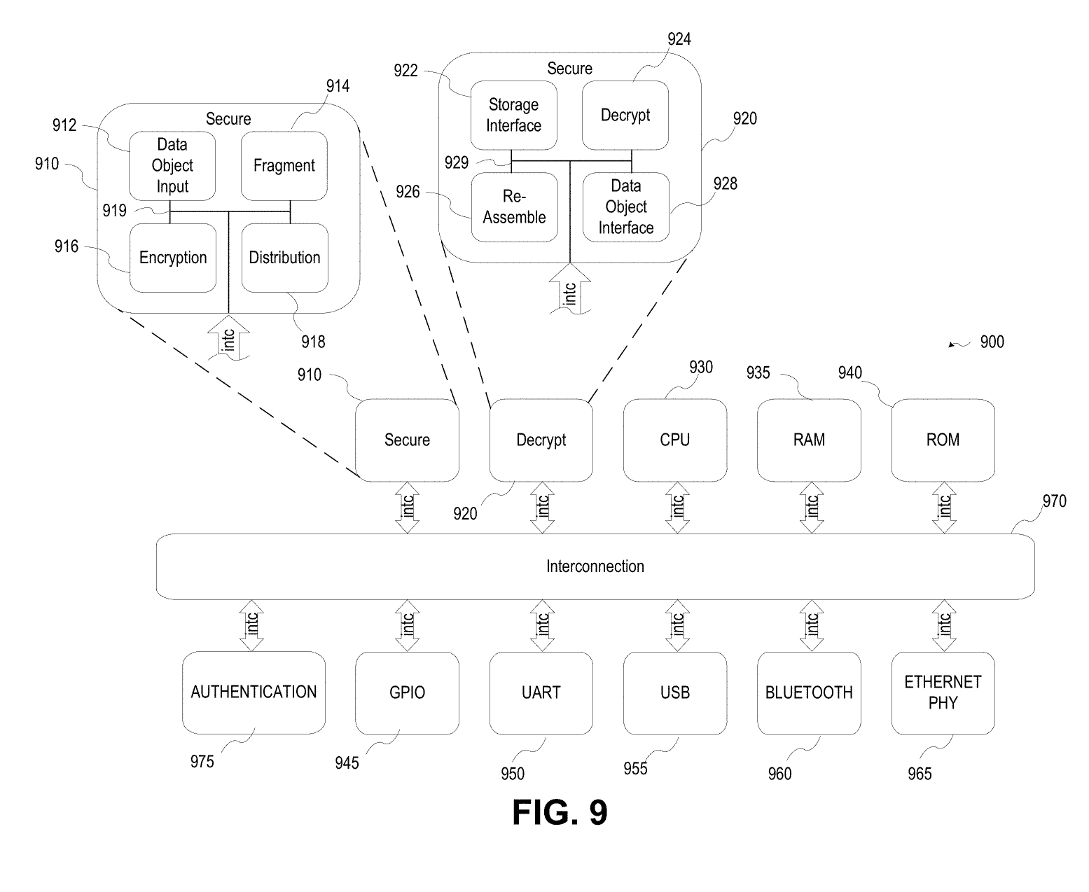

FIG. 9 is a schematic diagram illustrating an example of top-level block diagram for an example IC 900. FIG. 9 may be illustrative of an example implementation as a system on a chip in accordance with the various aspects of the present disclosure. The diagram of FIG. 9 shows data communication between various IP blocks included in the IC. The illustrated example IC 900 comprises a secure IP block 910 and a decrypt IP block 920. The IC 900 also comprises, for example, a plurality of optional blocks including, but not limited to, one or more authentication blocks 975 configured to authenticate users and/or devices in accordance with the aspects described in this present disclosure and/or the related Applications, one or more central processing unit (CPU) blocks 930 (shown as a single IP block for illustrative purposes only), a random access memory (RAM) block 935, a read only memory (ROM) block 940, a general purpose I/O (GPIO) block 945, a universal asynchronous receiver-transmitter (UART) block 950, a universal serial bus (USB) block 955, a Bluetooth® block 960, an Ethernet PHY block 965, and a interconnect 970.

In various embodiments implemented as a SoC, data may be sent and/or received from the secure block 910 through pins or interconnects with interconnect 970. Interconnect 970 may be a data bus, a switch, a Network-on-Chip (NoC), wireless connection, etc. Similarly, data may be sent and/or received from the decrypt block 920 through pins or interconnects of interconnect 970. For example, each IP block in FIG. 9 may comprise one or more bus interconnect ports coupled to the interconnect 970 via one or more pins. The interconnect port may thus be used to perform data communication into and out of each block. Thus, through a protocol bus interconnect, the various IP blocks are communicatively coupled for data exchange and processing. In some embodiments, the interconnect is an asynchronous interconnect, which may permit one or more IP blocks to operate independently from each other. Therefore, in some embodiments, the secure IP block 910 may be asynchronous and independent from the decrypt IP block 920. Furthermore, in some embodiments, there may also be a plurality of control signals, clock pins, test control pins, etc. to and from the various other IP blocks of FIG. 9 that will connect to one or more of the other IP blocks or sub-blocks therein.

In various embodiments, the secure IP block 910 may comprise one or more sub-blocks configured to perform the processes and/or methodologies described in the present disclosure and in the related Applications. For example, as illustrated in FIG. 9, secure IP block 910 may comprise at least a data object input block 912, a fragmentation block 914, an encryption block 916, and a distribution block 918 connected via an interconnect 919 (e.g., a data bus, a switch, a Network-on-Chip (NoC), wireless connection, etc.). In some embodiments, block 910 can also be a plurality of IP blocks configured to parallelize the function across them in order to speed up the computation.

The data object input block 912 may be configured to receive an indication that a data object is being transmitted from a data source external to the secure IP block 910. The data object input block 912 may also receive the content of the data object in a sequential manner based on the content and/or format of the data object being transmitted. In some embodiments, the data object input block 912 may be communicatively coupled to one or more data storage locations or devices in which the data object may be received or retrieved. For example, in the embodiment illustrated in FIG. 9, the secure IP block 910 may be coupled to RAM 935 and/or ROM 940. Additionally, or alternatively, an external storage device may be coupled to the secure IP block 910 via USB block 955, Bluetooth® block 960 and/or Ethernet PHY block 965.

The data object input block 912 may then forward the data object to the fragmentation block 914, which may be configured to disassemble the data object into fragments using the processes described in the related Applications. In various embodiments, the fragmentation block 914 may also be configured to create manifests for the data fragments in accordance with the processes described in the related Applications. The manifests may comprise a plurality of unique IDs for each data fragment and a corresponding encryption key for that fragment.

The encryption block 916 may be configured to receive data fragments from the fragmentation block 914 and individually encrypt each fragment in accordance with the processes described in the related Applications. In some embodiments, each data fragment is encrypted, for example, as it is generated by the fragmentation block 914(e.g., in sequential order). That is, as the fragments are processed by the fragmentation block 914, encryption block 916 encrypts each data fragment. However, in some embodiments, data fragments may be encrypted in any order not only when they are generated. For example, in some embodiments, the encryption block 916 may delay until all data fragments are generated and then individually encrypt each fragment.

The encryption block 916 may also receive the manifest from the fragmentation block 914 and encrypt each data fragment based on a corresponding encryption key included in the manifest. In some embodiments, the encryption key used to encrypt each of the data fragments may be based on a current encryption algorithm, such as, but not limited to, an AES 256 bit encryption, 3DES encryption, blowfish encryption, RSA encryption, ECC encryption, etc. In some embodiments, the encryption block 916 may also be configured to encrypt the manifest in accordance with the related Applications. In some embodiments, the manifest is encrypted with a key derived using an encryption algorithm (for example, but not limited to, a Diffie-Hellman protocol). In some embodiments, the encryption key of the manifest may be regenerated and/or ratcheted in accordance with the description herein and in the related Applications.

Following encryption of the data fragments, the distribution block 918 may be configured to receive the encrypted data fragments from the encryption block 916. The distribution block 918 may then distribute the individually encrypted data fragments to a plurality of different data storage locations and/or devices in accordance with the processes of the related Applications. In various embodiments, distribution block 918 may distribute the encrypted manifest. In various embodiments, distribution of the data fragments and/or manifests may be based on a virtual cryptological container, for example, as described in the related Applications. Thus, the secure IP block, in some embodiments, may interface with a virtual file system for management and storage of the encrypted data. Additionally, alone or in combination, the distribution block 918 may interface with a local or locally connected data storage device for on-premise storage of the encrypted data fragments. Furthermore, the data fragments may be distributed to one or more remote devices in accordance with the related Applications. In some embodiments, the data fragments may be distributed to one or more memory blocks (e.g., to RAM 935 and/or ROM 940) within the IC 900. Thus, all processes executed by the IC 900 may be confined within the IC 900. However, this need not be the case, and the processes of IC 900 may be distributed across a broad distributed network or cloud infrastructure.

In various embodiments, the decrypt IP block 920 may comprise one or more sub-blocks configured to perform the processes and/or methodologies described in the present disclosure. For example, as illustrated in FIG. 9, decrypt IP block 920 may comprise at least a storage interface block 922, a decryption block 924, a fragment re-assembly block 926, and a data object interface block 928 connected via an internal data bus 929. In some embodiments, block 920 can also be a plurality of IP blocks configured to parallelize the functions across them in order to speed up the computation.

The storage interface block 922 may be configured to receive one or more manifests from accessed data storage. In some embodiments, receiving the manifest may be in response to a request to retrieve a data object from the data storage. The accessed data storage may be based, for example, on a virtual cryptological container in which the manifest and/or requested data object is virtually stored within, in accordance with the related Applications. The data storage interface block 922 may decrypt each received manifest and request the corresponding data fragments identified in the manifest from the data storage in which the data fragments are stored. In some embodiments, the manifest may be received from one or more memory blocks (e.g., to RAM 935 and/or ROM 940) within the IC 900. Thus, all processes executed by the IC 900 may be confined within the IC 900, for example received from an external storage location. However, this need not be the case, and the processes of IC 900 may be distributed across a broad distributed network or cloud infrastructure.

In some embodiments, the data storage interface block 922 may be configured to access a manifest decryption key, for example, based on a known encryption algorithm and a seed parameter. In some embodiments, the manifest key may be ratcheted and/or regenerated as described in the related Applications. The data storage interface block 922 may then receive the data fragments from the plurality of different storage locations. That is, the storage interface block may perform data retrieval as described in the related Applications, for example, in at least the '294, '466, '058, and '* * * * * * Applications. In some embodiments, the data fragments may be received from one or more memory blocks (e.g., to RAM 935 and/or ROM 940) within the IC 900. Thus, all processes executed by the IC 900 may be confined within the IC 900, for example received from an external storage location. However, this need not be the case, and the processes of IC 900 may be distributed across a broad distributed network or cloud infrastructure.

In various implementations, the requested data object may have been secured using the processes described in the related Applications. Similarly, the data object may have been secured via a secure IP block similar to secure IP block 910 described above. In some embodiments, the data object may have been secured by secure IP block 910 of a device and/or SoC comprising the decryption block 924. In other embodiments, alone or in combination, the data object may have been secured by a device external to the decryption block 924. The device may have accessed a system via a client running on the device (e.g., as described above) and/or the device may comprise a secure IP block similar to secure IP block 910 for securing the data object as described herein.

The decryption block 924 may receive the data stored in the decrypted manifest from the data storage interface block 922 and use this data to individually decrypt each of the data fragments received from the data storage interface block 922. In some embodiments, each data fragment is decrypted as it is received by the decryption block 924; that is, as the fragments are accessed by the data storage interface block 922, the decryption block 924 decrypts each data fragment. However, in some embodiments, data fragments may be decrypted in any order, not only the order that they are received in. For example, in some embodiments, the decryption block 924 may delay until all data fragments are accessed and then individually decrypt each fragment.

The fragment re-assembly block 926 may be configured to receive the decrypted data fragments and re-assemble the fragments, for example, based on the requested data object. For example, for viewing of the data object, the fragments may need to be re-assembled in a predefined order. The fragment re-assembly block 926 may receive the decrypted manifest corresponding to the fragments, determine the predefined order from the manifest, and reassemble the data fragments. In some embodiments, the manifest may include an indicator of the predefined order for the data fragments. The fragment re-assembly block 926 may be configured to perform all the steps to reassemble the data object in accordance with the processes described in the related Applications.

The data object interface block 928 may receive the re-assembled data object and send the data object to the data bus. In some embodiments, the data bus may be communicatively coupled to an application or other program for playback or otherwise viewing the data object by a user, and the data object interface block 928 may transmit the data object thereto. In some embodiments, the data object interface block 928 may be communicatively coupled to one or more data storage locations or devices in which the reassembled data object may be stored. For example, in the embodiment illustrated in FIG. 9, the decrypt IP block 920 may be coupled to RAM 935 and/or ROM 940. Additionally, or alternatively, an external storage device may be coupled to the decrypt block 920 via USB block 955, Bluetooth® block 960 and/or Ethernet PHY block 965.

In various embodiments, each IP block may be coupled to the interconnect 970 via one or more internal bus pins. Furthermore, additional pins may be included and configured to receive control signals, clock signals, test control signals, etc. from one or more IP blocks and/or external components. Such signals may be connected to either each block and/or each sub-block.

In some implementations, FIG. 9 may be representative of a system on a chip (SoC) design, in part, due to the various IP blocks included in the example IC 900. Thus, each IP block of FIG. 9 may be configured to execute one or more processes described herein. In various embodiments, a SoC design may comprise a plurality of IP blocks arranged on a single chip, for example, including the components of the systems described herein, for example, in connection with FIGS. 1-5 and the systems described within the related Applications. Furthermore, in embodiments where the IC described herein is implemented as SoC, the included plurality of IP blocks may be configured to execute any number of the processes described herein and in the related Applications.

In various embodiments, each IP block may be a standalone FPGA and/or ASIC. For example, the secure IP block 910 may be a standalone FPGA and/or ASIC comprising the plurality of sub-blocks 912-918 and configured to perform the processes as described above. Similarly, the decrypt IP block 920 may be a standalone FPGA and/or ASIC. In some embodiments, one or more of the IP blocks described herein may be included in a FPGA and/or ASIC implementation without departing from the scope of the present disclosure. For example, a FPGA or ASIC implementation may comprise both the secure IP block 910 and the decrypt IP block 920. Furthermore, in embodiments where the IP blocks are implemented as an FPGA or ASIC, data communication may take place via one or more I/O pins that interface the internals of the FPGA or ASIC chip to external components. Each IP block may be coupled for data exchanges via the I/O pins. Furthermore, additional I/O pins may be included and configured to receive control signals, clock signals, test control signals, etc. from one or more IP blocks and/or external components. Such signals may be connected to either each block and/or each sub-block.

Contemporary digital IC designs are usually based on a synchronous paradigm. They rely on the availability of a control signal, typically called clock, that controls the sequential logic of an IC. Thus, sequencing and control of events happen on predictive points in time, which allows designers to ignore wire and gate delays provided that a few timing constraints related to the clock signal are fulfilled. However, as process and chip variation get more aggressive and performance, area, and power budgets get tighter, synchronous timing constraints are becoming hard to meet. To cope with such problems, asynchronous (sometimes referred to as non-synchronous) techniques may be implemented with improved design space of an asynchronous paradigm. These techniques may partially or completely remove reliance on a clock signal and utilize a handshake protocols for control and sequencing of events instead.

Accordingly, various IC implementations as described herein, may utilize asynchronous techniques. That is, one or more of the IP blocks described herein may be an asynchronous block, such that the one or more IP blocks operate independent of other IP blocks in the IC (e.g., either included in the SoC or coupled to a standalone IP block). In various embodiments, the secure IP block 910 may be an asynchronous block, the decrypt IP block 920 may be an asynchronous block, or both the secure IP block 910 and the decrypt IP block 920 may be asynchronous blocks. In some embodiments, the interconnection 970 may also be asynchronous. Thus, the secure IP block 910 and/or decryption IP block 920 may operate independently.

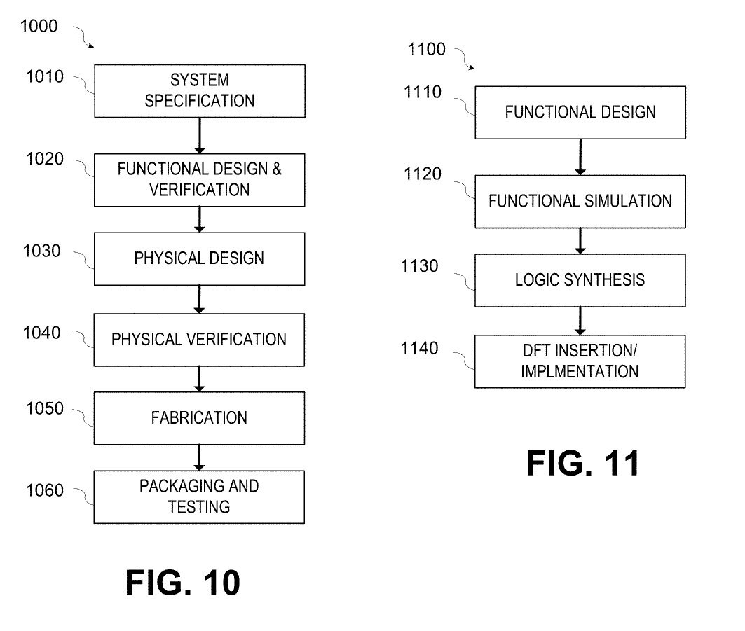

FIG. 10 is a flowchart illustrating an IC design flow 1000 in accordance with various aspects of the present disclosure. At block 1010, system specifications may be determined based on the functions and processes desired to be performed by the IC. For example, where the design is related to secure IP block 910, the systems requirements to perform functions of at least fragmentation, encryption, and distribution may be determined. Similarly, where the design is related to decrypt IP block 920, the systems requirements to perform functions of at least decryption and re-assembly may be determined.

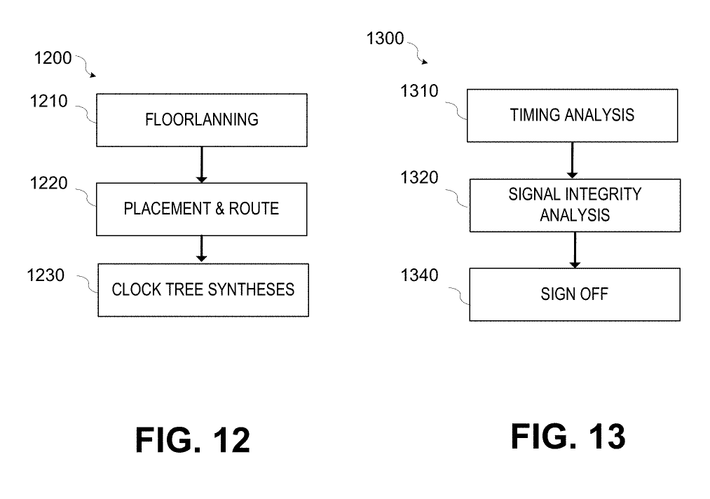

At block 1020, the functional design is formed based on, for example, the system specifications of secure IP block 910 and/or decrypt IP block 920. Functional design block 1020 may include simulation and verification of the functional design. An example functional design flow is illustrated in FIG. 11 described below. At block 1030 the functional design is synthesized into a physical design. An example physical design flow is illustrated in FIG. 12 described below. At block 1040, the physical design is simulated and verified for signoff for fabrication at block 1050 and packing and physical testing at block 1060. An example functional verification flow is illustrated in FIG. 13 described below.

FIG. 11 illustrates an example IC design flow 1100 in accordance with the various aspects of the present disclosure. As described above flow 1100 may be performed as part of an overall flow 1000, for example, at block 1020. In some embodiments, flow 1100 may be performed outside of flow 1000.

At block 1110, a functional design of a desired IC may be determined. For example, system specifications from block 1010 of FIG. 10 may be utilized to code the desired functions in register-transfer level (RTL) language, for example, but not limited to Verilog. At block 1120 the RTL design from block 1110 may be simulated and verified that the functions perform as desired. In some embodiments, block 1120 may include such techniques as simulation through test benches, formal verification, emulation, or creating and evaluating an equivalent pure software model. Block 1120 may comprise iterative steps of simulation and verification along with returning to block 1110 to revise and optimize the RTL design. Following verification of the RTL design, at block 1130, logic synthesis is performed to transform the RTL language to logic design. For example, predetermined cells (e.g., logic gates and components) may be stored in a library, which is accessed to construct a gate-level netlist design from the RTL language. The netlist comprises the resulting logic components and electric connections between them for construction of the IC. At block 1140, one or more design for testing (DFT) features are added into the netlist and are implemented to apply manufacturing tests to gate-level design of block 1130.

FIG. 12 illustrates an example IC design flow 1200 in accordance with the various aspects of the present disclosure. As described above flow 1200 may be performed as part of an overall flow 1000, for example, at block 1030. In some embodiments, flow 1200 may be performed outside of flow 1000.

At block 1210, floor planning is performed to design a schematic representation of the placement of the IP blocks. In some embodiments, block 1210 may be based in part on the gate-level netlist from flow 1100. In various embodiments, block 1210 may also be based on manufacturing specifications and die area of the resulting chip.

At step 1220, placement and routing may be performed. For example, the gate-level netlist may be processed (for example, by a placement tool) to place logic components onto die of semiconductor material based on the floor planning and representative of an arrangement of the IC. Placement may be performed in an iterative process to optimize the placement and floor planning. Routing may utilize the netlist from flow 1100 in combination with the resulting floor planning/placement from block 1220 to create electrical connections between the logic components. In some embodiments, block 1220 may produce a file from which photomasks and other fabrication techniques may be developed.

At block 1230, clock tree synthesis may be performed, which may comprise balancing a clock, for example, by inserting buffers in various electrical connections in order to minimize clock skew across the design. In some embodiments, blocks 1220 and 1230 are performed in parallel or in an iterative process, for example, where routing may include routing the electrical connections between IP blocks, routing one or more clock signals, and routing any remaining signals, then inserting buffers and optimizing the clock tree synthesis.

FIG. 13 illustrates an example IC design flow 1300 in accordance with the various aspects of the present disclosure. As described above, flow 1300 may be performed as part of an overall flow 1000, for example, at block 1040. In some embodiments, flow 1300 may be performed outside of flow 1000.

At block 1310, timing analysis may be formed on the resulting design. Timing analysis may be both static and dynamic to ensure signals from the clock are properly received by the logic components and that the components communicate and exchange signals as designed. For example, circuit extraction may be used to compute parasitic resistance and capacitance. Results of this computation may be mapped to delay information for estimating performance, for example, by static timing analysis. Dynamic timing analysis may comprise analyzing the IC design to ensure it operates fast enough to run without errors based on a target clock rate, for example, by simulating the physical functionality of the IC design.

At block 1320, the signal integrity is analyzed to ensure the IC functions correctly, for example, at extremes of operating parameters (e.g., voltage, temperature, load, etc.). For example, design rule checking, power analysis, etc. are performed on the various electrical connections to confirm integrity is within designed thresholds. At block 1330, the physical design is signed off for fabrication.

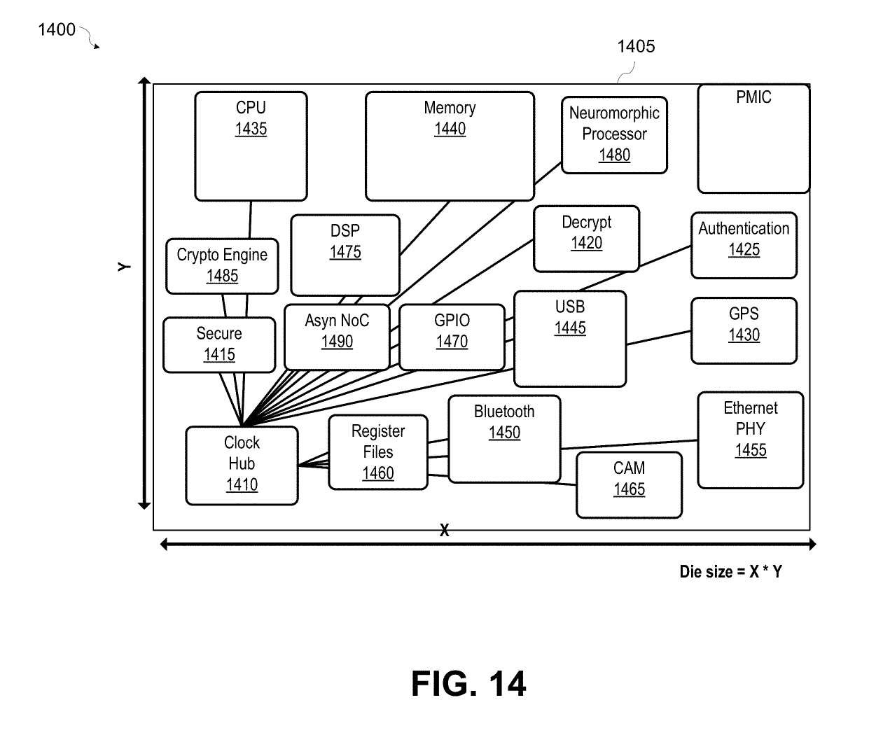

An example IC design 1400 in accordance with the various aspects of the present disclosure is illustrated in FIG. 14. For example, the IC design 1400 is a floorplan resulting from flow 1200. IC design 1400 may be fabricated on a die 1405 (e.g., semiconductor material) having dimensions of “x” and “y” and an area of (x×y). The IC design 1400 may include a clock hub 1410. By applying clock tree synthesis as described below in the IC design flow, a clock signal from the clock hub 1410 may be distributed to various IP blocks including, for example, but not limited to, a secure block 1415 (for example, secure IP block 910), a decrypt block 1420 (for example, decrypt IP block 920), an authentication block 1425 (for example, authentication IP block 975), a global positioning system (GPS) block 1430, a central processing unit (CPU) 1435, a memory block 1440, audio digital signal processor (DSP) 1475, a universal serial bus (USB) 1445, general purpose I/O Interface 1470 (e.g., for interfacing with external input and output devices, for example, but not limited, keyboards, mice, displays, speakers, etc.), register files 1460, a neuromorphic processor 1480, and a crypto engine 1485. Additionally, in some implementations, one or more buffers (not shown) may be inserted along the clock path from the clock hub 1410 to each of the IP blocks. The ASIC design 1400 may also include a Bluetooth® module 1450, a camera 1465, and an Ethernet module 1455.

### (c) Computer-Implemented Embodiment

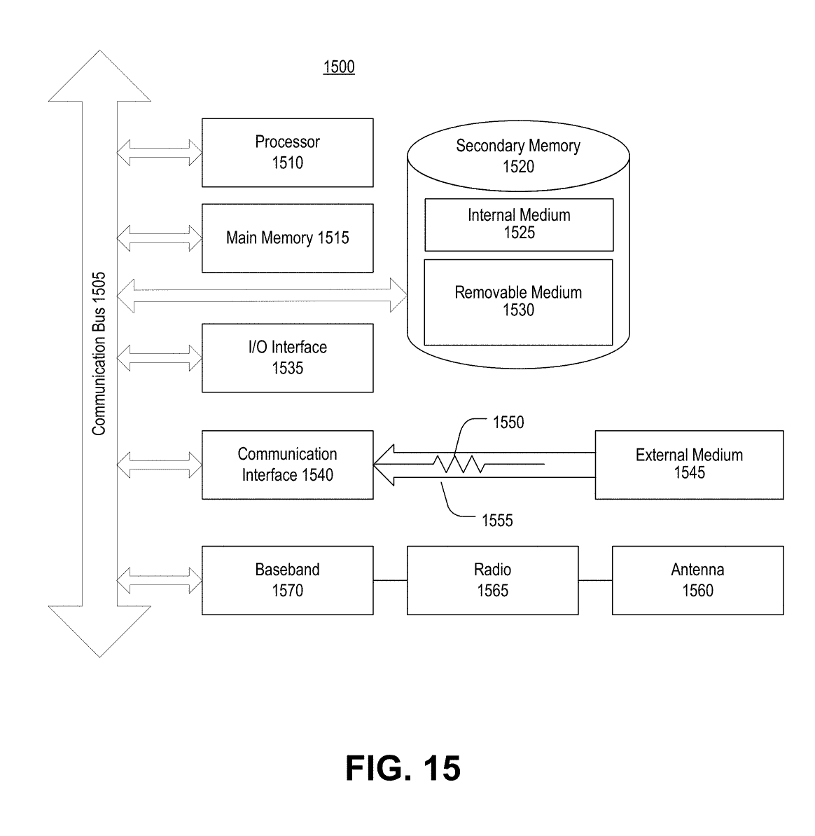

FIG. 15 is a block diagram illustrating wired or wireless system 1500 in accordance with various aspects of the present disclosure. In accordance with various aspects of the present disclosure, the system 1500 may be used in the implementation of the system described herein, for example, systems 100 and/or 600 of FIGS. 1-6.

In various embodiments, the system 1500 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 1500 may include one or more processors, such as processor 1510. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 1510.

The processor 1510 may be connected to a communication bus 1505. The communication bus 1505 may include a data channel for facilitating information transfer between storage and other peripheral components of the system 1500. The communication bus 1505 may further provide a set of signals used for communication with the processor 1510, including a data bus, address bus, and control bus (not shown). The communication bus 1505 may be any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 1500 may include a main memory 1515 and may also include a secondary memory 1520. The main memory 1515 may provide storage of instructions and data for programs executing on the processor 1510. The main memory 1515 is typically semiconductor-based memory such as dynamic random-access memory (“DRAM”) and/or static random-access memory (“SRAM”). Other semiconductor-based memory types include, for example, synchronous dynamic random-access memory (“SDRAM”), Rambus dynamic random-access memory (“RDRAM”), ferroelectric random-access memory (“FRAM”), and the like, including read only memory (“ROM”).

The secondary memory 1520 may optionally include an internal memory 1525 and/or a removable storage medium 1530, for example a floppy disk drive, a magnetic tape drive, a compact disc (“CD”) drive, a digital versatile disc (“DVD”) drive, etc. The removable storage medium 1530 is read from and/or written to in a well-known manner. Removable storage medium 1530 may be, for example, a floppy disk, magnetic tape, CD, DVD, SD card, etc.

The removable storage medium 1530 is a non-transitory computer readable medium having stored thereon computer executable code (i.e., software) and/or data. The computer software or data stored on the removable storage medium 1530 is read into the system 1500 for execution by the processor 1510.

In alternative embodiments, the secondary memory 1520 may include other similar means for allowing computer programs or other data or instructions to be loaded into the system 1500. Such means may include, for example, an external storage medium 1545 and a communication interface 1540. Examples of external storage medium 1545 may include an external hard disk drive or an external optical drive, or and external magneto-optical drive.

Other examples of secondary memory 1520 may include semiconductor-based memory such as programmable read-only memory (“PROM”), erasable programmable read-only memory (“EPROM”), electrically erasable read-only memory (“EEPROM”), or flash memory (block-oriented memory similar to EEPROM). Also included are the removable storage medium 1530 and a communication interface, which allow software and data to be transferred from an external storage medium 1545 to the system 1500.

System 1500 may also include an input/output (“I/O”) interface 1535. The I/O interface 1535 facilitates input from and output to external devices. For example, the I/O interface 1535 may receive input from a keyboard, mouse, touch screen, voice command, etc. and may provide output to a display. The I/O interface 1535 is capable of facilitating input from and output to various alternative types of human interface and machine interface devices alike.

System 1500 may also include a communication interface 1540. The communication interface 1540 allows software and data to be transferred between system 1500 and external devices (e.g. printers), networks, or information sources. For example, computer software or executable code may be transferred to system 1500 from a network server via communication interface 1540. Examples of communication interface 1540 include a modem, a network interface card (“NIC”), a wireless data card, a communications port, an infrared interface, and an IEEE 1394 fire-wire, just to name a few.

Communication interface 1540 implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 1540 are generally in the form of electrical communication signals 1550. The electrical communication signals 1550 are preferably provided to communication interface 1540 via a communication channel 1555. In various embodiments, the communication channel 1555 may be a wired or wireless network, or any variety of other communication links. Communication channel 1555 carries the electrical communication signals 1550 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 1515 and/or the secondary memory 1520. Computer programs can also be received via communication interface 1540 and stored in the main memory 1515 and/or the secondary memory 1520. Such computer programs, when executed, enable the system 1500 to perform the various functions of the present invention as previously described.

In this disclosure, the term “computer readable medium” is used to refer to any non-transitory computer readable storage media used to provide computer executable code (e.g., software and computer programs) to the system 1500. Examples of these media include main memory 1515, secondary memory 1520 (including internal memory 1525, removable storage medium 1530, and external storage medium 1545), and any peripheral device communicatively coupled with communication interface 1540 (including a network information server or other network device). These non-transitory computer readable mediums are means for providing executable code, programming instructions, and software to the system 1500.

In an embodiment that is implemented using software, the software may be stored on a computer readable medium and loaded into the system 1500 by way of removable storage medium 1530, I/O interface 1535, or communication interface 1540. In such an embodiment, the software is loaded into the system 1500 in the form of electrical communication signals 1550. The software, when executed by the processor 1510, preferably causes the processor 1510 to perform the inventive features and functions previously described herein.

The system 1500 may include optional wireless communication components that facilitate wireless communication over a voice and over a data network. The wireless communication components include an antenna system 1560, a radio system 1565 and a baseband system 1570. In the system 1500, radio frequency (“RF”) signals are transmitted and received over the air by the antenna system 1560 under the management of the radio system 1565.

In various embodiments, the antenna system 1560 may include one or more antennae and one or more multiplexors (not shown) that perform a switching function to provide the antenna system 1560 with transmit and receive signal paths. In the receive path, received RF signals can be coupled from a multiplexor to a low noise amplifier (not shown) that amplifies the received RF signal and sends the amplified signal to the radio system 1565.

In alternative embodiments, the radio system 1565 may include one or more radios that are configured to communicate over various frequencies. In one embodiment, the radio system 1565 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 1565 to the baseband system 1570.

If the received signal contains audio information, then baseband system 1570 decodes the signal and converts it to an analog signal. Then the signal is amplified and sent to a speaker. The baseband system 1570 also receives analog audio signals from a microphone. These analog audio signals are converted to digital signals and encoded by the baseband system 1570. The baseband system 1570 also codes the digital signals for transmission and generates a baseband transmit audio signal that is routed to the modulator portion of the radio system 1565. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 1560 where the signal is switched to the antenna port for transmission.

The baseband system 1570 is also communicatively coupled with the processor 1510. The processor 1510 has access to one or more data storage areas including, for example, but not limited to, the main memory 1515 and the secondary memory 1520. The processor 1510 is preferably configured to execute instructions (i.e., computer programs or software) that can be stored in the main memory 1515 or in the secondary memory 1520. Computer programs can also be received from the baseband system 1570 and stored in the main memory 1515 or in the secondary memory 1520 or executed upon receipt. Such computer programs, when executed, enable the system 1500 to perform the various functions of the present invention as previously described. For example, the main memory 1515 may include various software modules (not shown) that are executable by processor 1510.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general-purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

### (d) Additional Features

While various embodiments have been described above, it should be understood that they have been presented by way of example only, and not of limitation. The breadth and scope should not be limited by any of the above-described example embodiments. Where this document refers to technologies that would be apparent or known to one of ordinary skill in the art, such technologies encompass those apparent or known to the skilled artisan now or at any time in the future. In addition, the described embodiments are not restricted to the illustrated example architectures or configurations, but the desired features can be implemented using a variety of alternative architectures and configurations. As will become apparent to one of ordinary skill in the art after reading this document, the illustrated embodiments and their various alternatives can be implemented without confinement to the illustrated example. One of ordinary skill in the art would also understand how alternative functional, logical or physical partitioning and configurations could be utilized to implement the desired features of the described embodiments.

Furthermore, although items, elements or components can be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases can be absent.

While various embodiments have been described above, it is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. The accompanying claims and their equivalents are intended to cover such forms or modifications as would fall within the scope and spirit of the protection. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed:

1. A method for reducing race conditions, the method comprising:
receiving, by a server from a plurality of client devices, a plurality of requests to retrieve a first data object, each client device operated by a user of a plurality of users;
generating a plurality of unique data objects based on the requested first data object, each unique data object associated with the first data object and associated with a user of the plurality of users; and
for each client device of the plurality of client devices, providing the client device access to a respective unique data object of the plurality unique data objects based on a respective user corresponding to the client device and associated with the respective unique data object.

2. The method of claim 1, wherein at least two or more of the plurality of client devices are provided access to each respective unique data object during overlapping time periods.

3. The method of claim 2, wherein each client device is provided access to the respective unique data object only.

4. The method claim 1, wherein at least the first data object is disassembled into data fragments and the data fragments are stored in a plurality of different data storage locations.

5. The method claim 1, further comprising, in response to receiving one or more of the plurality of requests, retrieving data access information corresponding to the first data object, the data access information comprising the associations of the first data object with the plurality of unique data objects and the associations of the plurality of unique with the plurality of users.

6. The method of claim 5, wherein the data access information further comprises data indicative of a plurality of actions performed by the plurality of client devices with respect to the first data object, wherein the plurality of actions comprises actions performed on one or more of: the first data object and each of the plurality of unique data objects.

7. The method of claim 5, wherein the data access information comprises a first data object identifier, wherein the method further comprises:
translating the first object data identifier into a plurality of unique data object identifiers corresponding to the plurality of unique data objects; and
storing the plurality of unique data object identifiers in association with the plurality of users in the data access information.

8. The method of claim 5, further comprising monitoring activity over the server with respect to the first data object based, in part, on the data access information.

9. A method for accessing a first data object, the method comprising:
receiving, by a server from a first client device operated by a first user, a request to retrieve the first data object;
in response to receiving the request from the first client device, retrieving, by the server, a second data object associated with the first user and with the first data object; and
providing the first client device access to the second data object.

10. The method of claim 9, further comprising:
receiving, from a second client device operated by a second user by the server, a request to retrieve the first data object;
in response to receiving the request from the second client device, retrieving, by the server, a third data object associated with the second user and with the first data object; and
providing the second client device access to the third data object.

11. The method of claim 10, wherein the first and second client devices access the first and second data objects, respectively, during overlapping time periods.

12. The method of claim 9, wherein the first data object is associated with data access information, the data access information comprising a first data object identifier corresponding to the first data object and a second data object identifier corresponding to the second data object and associated with the first user.

13. The method of claim 9, further comprising, in response to receiving the request to retrieve the first data object:
accessing data access information corresponding to the requested first data object; and
determining whether the second data object exists.

14. The method of claim 13, further comprising, if the second data object does not exist, generating a second data object based on the first data object, and associating the second data object with first data object and the first user.

15. A system for accessing a first data object, the system comprising:
one or more storage locations configured to store the first data object, a plurality of unique data objects, the first data object being stored in association with the plurality of unique data objects and the plurality of unique data objects are stored in association with a plurality of users;
a plurality of client devices comprising one or more processors, the plurality of client devices operated by a plurality of users;
a secure platform comprising one or more processors and coupled to the one or more storage locations, the secure platform configured to:
receive a request to retrieve the first data object from a first client device of the plurality of client devices,
in response to receiving the request from the first client device, retrieve a second data object of the plurality of data objects associated with the first data object and associated with a first user of the plurality of users, and
provide the first client device access to the second data object.

16. The system of claim 15, wherein the plurality of client devices comprises a second client device, the server further configured to:
receive a request to retrieve the first data object from a second client device;
in response to receiving the request from the second client device, retrieve a third data object associated with the first data object and associated with a second user; and
provide the second client device access to the third data object.

17. The system of claim 15, wherein the one or more storage locations are configured to store a plurality of first data objects and corresponding data access information, each comprising a first data object identifier corresponding to a respective first data object, a respective plurality of unique data object identifiers associated with the first data object identifier, each unique data object identifier associated with a user of the plurality of users.

18. The system of claim 15, wherein the one or more storage locations are configured to store a plurality of first data objects and corresponding data access information, each comprising a first data object identifier corresponding to a respective first data object, a respective plurality of unique data object identifiers associated with the first data object identifier, each unique data object identifier associated with a user of the plurality of users

19. The system of claim 18, wherein the data access information further comprises data indicative of a plurality of actions performed with respect to the respective first data object, wherein the plurality of actions comprises actions performed by the plurality of client devices on one or more of: the respective first data object and each of the plurality of unique data objects.

20. The system of claim 19, wherein the server is further configured to monitoring activity over the server with respect to each of the first data objects based, in part, on the corresponding data access information.
